(19) United States
(12) Patent Application Publication
(10) Pub. No.: US 2006/0012741 A1
(43) Pub. Date: Jan. 19, 2006

(54) Vertical alignment liquid crystal display device

(75) Inventor: Ryota Mizusako, Sagamihara-shi (JP)

Correspondence Address: FRISHAUF, HOLTZ, GOODMAN & CHICK, PC, 220 5TH AVE FL 16, NEW YORK, NY, 10001-7708, US

(73) Assignee: Casio Computer Co., Ltd., Tokyo (JP)

(21) Appl. No.: 11/182,233

(22) Filed: Jul. 15, 2005

(30) Foreign Application Priority Data
Jul. 16, 2004 (JP) 2004-210412
Jul. 13, 2005 (JP) 2005-204619

(51) Int. Cl. G02F 1/1337

(52) U.S. Cl. 349/130

(57) ABSTRACT

A liquid crystal with a negative dielectric anisotropy is filled between a pair of substrates, on one of which an opposing electrode is provided while pixel electrodes and an auxiliary electrode formed around the pixel electrode are provided. The pixel electrode is a transparent electrode comprising an ITO layer, and is formed with a slit for segmenting a pixel region into a plurality of sub-pixel regions. The slit is formed from the center portion of each pixel toward and the peripheral portion thereof. The auxiliary electrode is also formed under the pixel electrode at a position which corresponds to the slit. Liquid crystal molecules of each sub-pixel region are so aligned as to tilt toward the center of the sub-pixel region when a voltage is applied between the pixel electrode and the opposing electrode.

### BACKGROUND OF THE INVENTION

1. Field of the Invention

The present invention relates to a vertical alignment liquid crystal display device.

2. Description of the Related Art

A conventional TFT liquid crystal panel comprises a TFT (Thin Film Transistor) substrate, a CF (Color Filter) substrate, and a liquid crystal layer which is sandwiched between those substrates. As a liquid crystal material, which is filled between the TFT substrate and the CF substrate, a material with the positive dielectric anisotropy is used for a TN (Twisted Nematic) display. As a liquid crystal display device using a material with the negative dielectric anisotropy, a vertical alignment TFT liquid crystal display has been proposed, which directs the liquid crystal director (molecular long axis direction) toward the direction perpendicular to the substrate in no electric field.

In the vertical alignment TFT liquid crystal display device, a liquid crystal with the negative dielectric anisotropy is filled between a pair of substrates which are arranged opposite to each other, thereby constituting a liquid crystal cell.

Pixel electrodes are formed, pixel by pixel, on one of the pair of substrates, a common (opposing) electrode which faces the picture electrodes is formed on the other substrate, with one pixel being formed by each pixel electrode, the opposing portion of the common electrode, and the liquid crystal therebetween. A vertical alignment film, which is rubbed to define a direction in which the liquid crystal molecules tilt when a voltage is applied between the pixel electrode and the opposing electrode, is so formed on each substrate as to cover the pixel electrode and the common electrode.

In a case where no voltage is applied between the pixel electrode and the opposing electrode, because the common electrode and the pixel electrode have the same electric potential, no electric field is formed between those electrodes, and, because of the negative dielectric anisotropy and the action of the vertical alignment film, the liquid crystal molecules are vertically aligned relative to the substrate.

When a voltage is applied between the pixel electrode and the common electrode, the liquid crystal molecules behave to tilt because of the electric field formed between those electrodes, and, when a sufficiently high voltage is applied between those electrodes, the liquid crystal molecules are aligned substantially homogeneous with the substrate.

In this case, when a voltage is applied between the pixel electrode and the common electrode, the liquid crystal molecules are aligned along one direction due to the electric field formed between those electrodes, thereby providing a large view angle dependency of the contrast and a poor view angle characteristic.

To obtain the wide view angle characteristic in the vertical alignment liquid crystal display apparatus, it is proposed to form a plurality of domains where the liquid crystal molecules are aligned along plural directions pixel by pixel. For instance, as described in the specification of Japanese Patent Publication No. 2565639, a liquid crystal display apparatus proposed has the common electrode formed with an aperture with the shape of a letter X, and, the liquid crystal molecules in each pixel are so aligned as to tilt toward the center of the X-shaped aperture along the four directions when a voltage is applied between the pixel electrode and the common electrode laid out opposite to each other.

In this liquid crystal display apparatus, the common electrode is formed larger than the pixel electrode, and, when a voltage is applied between the pixel electrode and the common electrode, a vertical electric field is generated at that portion of the pixel region where the pixel electrode is opposite to the common electrode, an oblique electric field is generated at the peripheral portion of the pixel electrode, and a discontinuous electric field is generated at that portion of the common electrode where the slit is formed. As a result, the liquid crystal molecules are aligned to tilt toward the center of the X-shaped aperture. That is, in this liquid crystal display apparatus, the liquid crystal molecules are so aligned as to incline along the four directions for each pixel and for each region defined by the X-shaped aperture.

According to the above-described liquid crystal display apparatus, however, because the X-shaped aperture formed in each pixel forms regions with different alignment directions, the X-shaped aperture should be formed wide enough to prevent the interaction between the regions. Accordingly, in each pixel, the area of the slit which is not controllable by the electric field becomes large, and the area of the common electrode becomes small, resulting in a low aperture ratio.

### SUMMARY OF THE INVENTION

It is an object of the present invention is to provide a liquid crystal display device with a wide view angle, a high transmittance, and a high contrast.

To achieve the object, a liquid crystal display device, according to the first aspect of the present invention, is a liquid crystal display device which comprises:

one substrate;

another substrate arranged opposite to the one substrate with a predetermined gap therebetween;

at least one first electrode formed on one surface of opposing surfaces of the one substrate and the other substrate;

a plurality of second electrodes formed on another surface of the opposing surfaces, each formed with a plurality of single pixels each being a region of a minimum display unit by that region which faces the first electrode, and having an aperture for segmenting each pixel into a plurality of sub-pixel regions for each pixel;

a vertical alignment film formed on each of opposing inner surfaces of the one substrate formed with the first electrode and the other substrate formed with the second electrodes;

a liquid crystal layer with a negative dielectric anisotropy filled between the substrates; and

an auxiliary electrode formed on a peripheral region which surrounds at least the second electrode.

The liquid crystal display device of the first aspect has the aperture which is provided in the second electrode to segment each pixel into a plurality of sub-pixel regions, and the auxiliary electrode which is formed on that peripheral portion which surrounds at least the second electrode. Accordingly, the liquid crystal molecules are radially aligned in such a manner as to be continuous from the periphery of each sub-pixel region to the center thereof, the central location of the radial alignment can be stabilized. Therefore, the alignment for each pixel can be stabilized, and the display unevenness does not occur.

In the liquid crystal display device, it is preferable that the auxiliary electrode should be formed in such a manner as to surround each of the plural sub-pixel regions segmented by the aperture, and so provided as to be associated with the peripheral portion of the second electrode and the aperture.

It is desirable that the aperture should comprise, for each of the second electrodes, a plurality of slits which extend from a center of the second electrode to a periphery thereof, and are connected to one another at a center of the pixel electrode, and, the aperture should be formed in the second electrode connected to an active device.

In this case, it is desirable that the auxiliary electrode should be formed on a surface of the other substrate, and the second electrode should be formed on an insulation film which covers the auxiliary electrode on the other substrate.

It is desirable that a voltage, which is applied to the first electrode formed on the one substrate, should be applied to the auxiliary electrode.

As stated above, as the auxiliary electrode is provided in association with the aperture, and as the voltage applied to the first electrode is also applied to the auxiliary electrode, no electric field is generated at the region corresponding to the aperture. Accordingly, the action of the aperture formed in the second electrode can be made large, and the width of the aperture can be narrowed. As a result, the area of the second electrode for each pixel become larger, and a portion which is not controlled by an electric field in each pixel is reduced, thereby enlarging the aperture ratio of the pixel.

A liquid crystal display device according to the second aspect of the present invention, is a liquid crystal display device which comprises:

one substrate;

another substrate which is arranged opposite to the one substrate with a predetermined gap therebetween;

at least one first electrode formed on that surface of the one substrate which faces the other substrate;

a plurality of second electrodes formed on that surface of the other substrate which faces the one substrate, each formed with a plurality of single pixels defined by a region facing the first electrode, and having a slit for segmenting each pixel into a plurality of sub-pixel regions for each pixel;

a vertical alignment film formed on each of that surface of the one substrate on which the first electrode is formed and that surface of the other substrate on which the second electrodes are formed;

a liquid crystal layer with a negative dielectric anisotropy filled between the substrates;

a first auxiliary electrode, formed on that surface of the other substrate on which the second electrodes are provided at a peripheral region surrounding at least the second electrodes, for aligning liquid crystal molecules located at a periphery of a pixel of the liquid crystal layer in such a way that a molecular long axis of the liquid crystal molecules tilt from a periphery to a center by an electric field applied between the first auxiliary electrode and the second electrode; and

a second auxiliary electrode, formed on that surface of the other substrate on which the second electrodes are formed at a region corresponding to the slit, for aligning liquid crystal molecules located at a periphery of a sub-pixel region of the liquid crystal layer, for each sub-pixel region, in such a way that the molecular long axis of the liquid crystal molecules tilt from a periphery to a center by an electric field applied between the second auxiliary electrode and the second electrode.

According to the liquid crystal display device of the second aspect, the liquid crystal molecules in each pixel are radially aligned in such a manner as to be continuous from the periphery of each sub-pixel region to the center of the aperture in each sub-pixel region, and the central location of the radial alignment can be stabilized. Accordingly, the alignment for each pixel can be stabilized, and the display unevenness does not occur.

In the liquid crystal display device, it is desirable that the slit should comprise a plurality of notch sections formed in such a way as to extend from a center of the pixel region to a periphery thereof and be connected to one another at a center portion of the pixel region, and, the slits should be formed in the second electrode connected to the active device.

It is desirable that the first and second auxiliary electrodes should be formed on a surface of the other substrate, and the second electrode should be formed on an insulation film which covers the first and second auxiliary electrodes on the other substrate, and the first auxiliary electrode and the second auxiliary electrode are formed on a surface of the other substrate so as to be connected to each other, in an integral manner.

It is desirable that the first and second auxiliary electrodes should be set to lower electric potentials than an electric potential of the second electrode, and to be more precise, they should be set to an electric potential equal to an electric potential of the first electrode opposite to the second electrode.

It is preferable that the first auxiliary electrode should comprise a compensating-capacitor electrode which overlaps the peripheral portion of the second electrode, and forms a compensating capacitor between the second electrode and the compensating-capacitor electrode, the second auxiliary electrode should be formed wider than a width of the slit of the second electrode, and that region of the second auxiliary electrode which overlaps the second electrode should form a compensating capacitor between the second electrode and the second auxiliary electrode, and each of the first and second auxiliary electrodes should comprise a transparent conductive film.

The liquid crystal display device, according to the third aspect of the present invention, is a liquid crystal display device which comprises:

one substrate;

another substrate arranged opposite to the one substrate with a predetermined gap therebetween;

at least one first electrode formed on one surface of opposing surfaces of the one substrate and the other substrate;

a plurality of second electrodes formed on another surface of the opposing surfaces, and each formed with a plurality of single pixels each being a region of a minimum display unit by that region which faces the first electrode;

a vertical alignment film formed on each of opposing inner surfaces of the one substrate formed with the first electrode and the other substrate formed with the second electrodes;

a liquid crystal layer with a negative dielectric anisotropy filled between the substrates; and

segmentation means, provided on the second electrode, for segmenting each pixel into a plurality of sub-pixel regions; and

alignment means, provided on the second substrate, for aligning liquid crystal molecules located around the sub-pixel region of the liquid crystal layer in such a way tat a molecular long axis tilt from a periphery to a center for each sub-pixel region.

According to the liquid crystal display device of the third aspect, the liquid crystal molecules in each pixel are radially aligned in such a manner as to be continuous from the periphery of each sub-pixel region to the center of the aperture in each sub pixel region, and the central location of the radial alignment can be stabilized. Accordingly, the alignment for each pixel can be stabilized, and the display unevenness does not occur.

In the liquid crystal display device, it is preferable that the segmentation means should comprise a plurality of slits formed on the second electrode, and the alignment means should comprise auxiliary electrodes formed on that surface of the other substrate on which the second electrodes are formed at a peripheral region surrounding at least the second electrodes, and a region corresponding to the segmentation means.

### BRIEF DESCRIPTION OF THE DRAWINGS

These objects and other objects and advantages of the present invention will become more apparent upon reading of the following detailed description and the accompanying drawings in which:

FIG. 1 is a cross sectional view illustrating the structure of a liquid crystal display device according to a first embodiment of the present invention;

FIGS. 2A, 2B, and 2C illustrate the structure of the portion which corresponds to one pixel in the liquid crystal display according to the first embodiment of the present invention, FIG. 2A is a top plan view, FIG. 2B is a cross sectional view of the structure in FIG. 2A taken along the line 2B-2B, and FIG. 2C is a cross-sectional view of the structure in FIG. 2A taken along the line 2C-2C;

FIGS. 3A and 3B exemplarily illustrate an electric field generated at the liquid crystal layer of the liquid crystal display device in FIG. 1 and the alignment of the liquid crystal molecules, FIG. 3A is an isoelectric line diagram, and FIG. 3B is a diagram illustrating the alignment states of the liquid crystal molecules;

FIG. 4 is a waveform chart for drive voltages illustrating the waveforms of the drive voltages applied to the individual electrodes of the liquid crystal display device in FIG. 1;

FIGS. 5A and 5B illustrate the alignment states of the liquid crystal molecules in each pixel, FIG. 5A illustrates the alignment states of the liquid crystal molecules located at the peripheral portion of each sub-pixel region, and FIG. 5B is an exemplary plan view illustrating the alignment states of the liquid crystal molecules for each sub-pixel region; and

FIGS. 6A, 6B, and 6C illustrate the structure of the portion which corresponds to one pixel in a liquid crystal display device according to a second embodiment of the present invention, FIG. 6A is a top plan view, FIG. 6B is a cross-sectional view of the structure in FIG. 6A taken along the line 6B-6B. FIG. 6C is a cross sectional view of the structure in FIG. 6A taken along the line 6C-6C.

### DETAILED DESCRIPTION OF THE PREFERRED EMBODIMENTS

Liquid crystal display devices will be described below as embodiments of the present invention with reference to the accompanying drawings.

[First Embodiment]

A liquid crystal display according to the embodiment will now be explained with reference to the accompanying drawings.

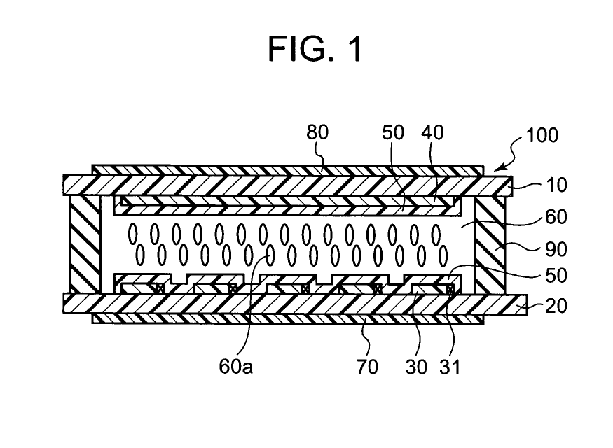

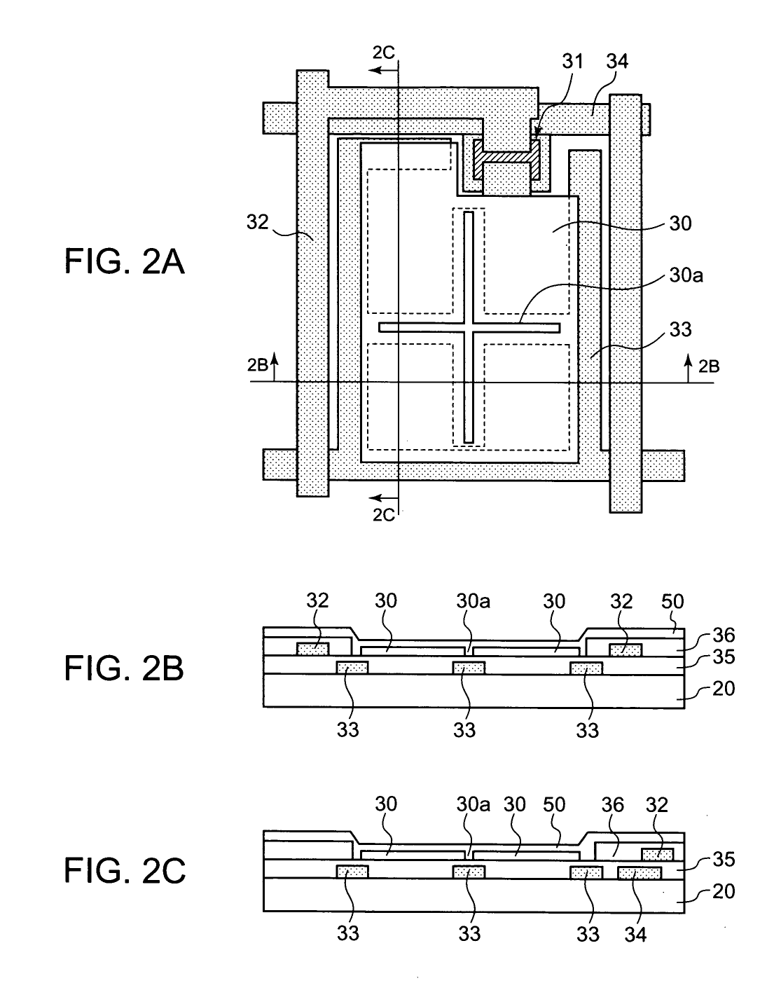

FIG. 1 is a cross-sectional view illustrating the schematic structure of the vertical alignment liquid crystal display device according to the first embodiment of the present invention, and FIG. 2A is a top plan view illustrating one pixel structure in the liquid crystal display device.

As illustrated in FIG. 1 and FIG. 2A, in the liquid crystal display device, a liquid crystal panel 100 comprises a pair of substrates 10 and 20, pixel electrodes 30 and an opposing electrode 40 formed on the surfaces of those substrates opposite to each other, alignment films 50, a seal material 90 for connecting the pair of substrates 10 and 20, and a liquid crystal layer 60 filled between the pair of substrates. The liquid crystal display device comprises the liquid crystal panel 100 and a pair of polarizing plates 70 and 80 which are placed outside the respective substrates 10 and 20 of the liquid crystal panel 100 in such a way as to sandwich those substrates therebetween.

The opposing electrode 40 and non-illustrated color filters are formed on the inner surface of one (10) of the pair of substrates 10 and 20.

Formed on the inner surface of the other substrate 20 are the pixel electrodes 30, TFT devices 31 which are connected to the pixel electrodes 30 to apply an image signal externally supplied to the pixel electrodes 30, drain lines 32 which supply the image signal to the TFT devices 31, an auxiliary electrode 33 for controlling and stabilizing the alignment of the liquid crystal molecules in each pixel and for forming a compensating capacitor (CS) between each pixel electrode 30 and itself, gate lines 34 which supply the TFT devices 31 with a gate signal for controlling the operation of the TFT devices 31, a gate insulation film 35 which covers the gate electrodes of the TFT devices 31, an insulation film 36 which covers the drain lines 32, and a vertical alignment film 50 which covers the surfaces of those films.

The TFT device 31, which is not illustrated in detail, is an inversely staggered type thin film transistor which is formed on the substrate.

The pixel electrode 30 is formed by an approximately quadrangle transparent electrode which comprises, for instance, an ITO (Indium Tin Oxide) film essentially consisting of an indium oxide. The pixel electrode 30 defines the region of a single pixel which is the smallest unit for forming an image. A narrow aperture for segmenting each pixel into a plurality of sub-pixel regions is formed in the pixel electrode 30 for each pixel. The aperture comprises a plurality of slits 30a which extend from the center of the pixel electrode 30 to the periphery thereof, and are connected to one another at the center of the pixel electrode 30. In the embodiment, the slits 30a are formed by incising the pixel electrode 30 in such a way as to extend along the vertical and horizontal directions at the center portion of the pixel electrode 30, and segment one pixel into four sub-pixel regions.

The drain line 32 comprises an aluminum line or the like which is so formed as to run along the column direction for each column of pixels. The drain line 32 is connected to the drain electrodes of TFT devices 31 in the same pixel column, and supplies the image signal from a column driver to the pixel electrode 30, via enabled TFT devices 31.

The auxiliary electrode 33 is made of aluminum or the like, and is formed around the pixel electrode 30 in such a way that the auxiliary electrode 33 partly overlaps the periphery portion of the pixel electrode 30 via the gate insulation film 35. The auxiliary electrode 33 is also formed under the pixel electrode 30 in association with the slits 30a in such a way as to be wider than the slits 30a and partly overlaps the periphery portions of the slits 30a The auxiliary electrode 33 is kept at a predetermined electric potential lower than that of the pixel electrode 30, and more preferably, set at the same electric potential as that of the opposing electrode 40, and, together with the pixel electrode 30, forms the compensating capacity (CS) which is connected in parallel to a pixel capacitor, formed by each pixel electrode 30, the opposing electrode 40 and the liquid crystal 60.

The gate line 34 comprises an aluminum line or the like which is so formed as to run along the row direction for each pixel row, and electrically isolated from the other electrodes by the gate insulation film 35. The gate line 34 is connected to the gate electrodes of the TFT devices 31 in the corresponding pixel row, supplies a scan signal to the TFT devices 31, and controls the ON/OFF actions of the TFT devices 31.

The gate insulation film 35 is formed on the substrate 20 where the gate electrodes of the TFT devices 31, the gate line 34, and the auxiliary electrode 33 are formed, and comprises, for instance, a silicon nitride film. The gate insulation film 35 electrically isolates the non-illustrated gate electrode of the TFT device 31 from a semiconductor layer and a source/drain electrode which are opposite to that gate electrode. The source electrode of the TFT device 31 is connected to the corresponding pixel electrode 30, and the drain electrode of the TFT device 31 is connected to the corresponding drain line 32.

The insulation film 36, which covers the drain line 32, is formed between the pixel electrode 30 and that of the neighboring pixel, and comprises, for instance, a silicon nitride film.

The vertical alignment film 50 comprises a hexamethyldisioxane-polymerization film or the like which is formed by, for example, CVD (Chemical Vapor Deposition). The vertical alignment film 50 is so formed as to cover the pixel electrode 30 formed on the substrate 10 and the opposing electrode 40 formed on the substrate 20. The liquid crystal 60 is filled between opposing vertical alignment films 50. The vertical alignment film 50 is not formed with any rubbing, and allows the liquid crystal molecules in the vicinity of the surface to be vertically aligned due to the alignment restraining force when no electric field is formed.

Next, the method for manufacturing the liquid crystal display device structured as stated will now be explained.

An aluminum film is formed on the glass substrate 20, and patterned to form the gate electrodes of the TFT devices 31, the gate lines 34, and the auxiliary electrodes 33 (including the lines which mutually connect the auxiliary electrode 33). Next, the gate insulation film 35 is formed by CVD. Subsequently, the semiconductor layers, the source and drain electrodes, etc. of the TFT devices 31 are formed on the gate insulation film 35.

Subsequently, an ITO film is formed on the gate insulation film 35 by sputtering. The ITO film is etched and patterned, excluding that portion of the ITO film which constitutes the pixel region, yielding the pixel electrodes 30 each formed with the narrow slits 30a extending toward the peripheral portion of the pixel region from the central portion of the pixel.

The drain lines 32 are formed on the gate insulation film 35, apart from the peripheries of the pixel electrodes 30, and are connected to the drain regions of the TFT devices 31. The insulation film 36 is formed on the gate insulation film 35 in such a manner as to cover the drain lines 32 formed on non-pixel regions around the pixel electrodes 30.

Subsequently, the vertical alignment film 50 is formed on the entire surface of the substrate by CVD, spin coating, etc.

The substrate 20 thus formed and the opposing substrate 10 thus formed with the opposing electrode, the color filters, etc., are arranged opposite to each other with a non-illustrated spacer sandwiched there between, and their peripheries are sealed by the seal material 90, thereby forming each liquid crystal cell. Next, the liquid crystal 60 is filled in the liquid crystal cell, and a non-illustrated liquid-crystal inlet is sealed. The polarizing plates 70 and 80 are placed on the outer surfaces of the substrates 20 and 10, thereby fabricating the liquid crystal display device.

Next, the behavior of the liquid crystal molecules in the pixel with the above described structure will be explained.

One pixel defined by a region where one pixel electrode 30 and the common electrode 40 face each other is separated into four sub-pixel regions by the plural slits 30a formed on the pixel electrode 30. The periphery of each sub-pixel region is surrounded by the auxiliary electrode 33, and, when a voltage is applied between the pixel electrode 30 and the auxiliary electrode 33, horizontal (in a direction parallel with the substrates 20 and 10) electric fields are generated at the four edges of each sub pixel.

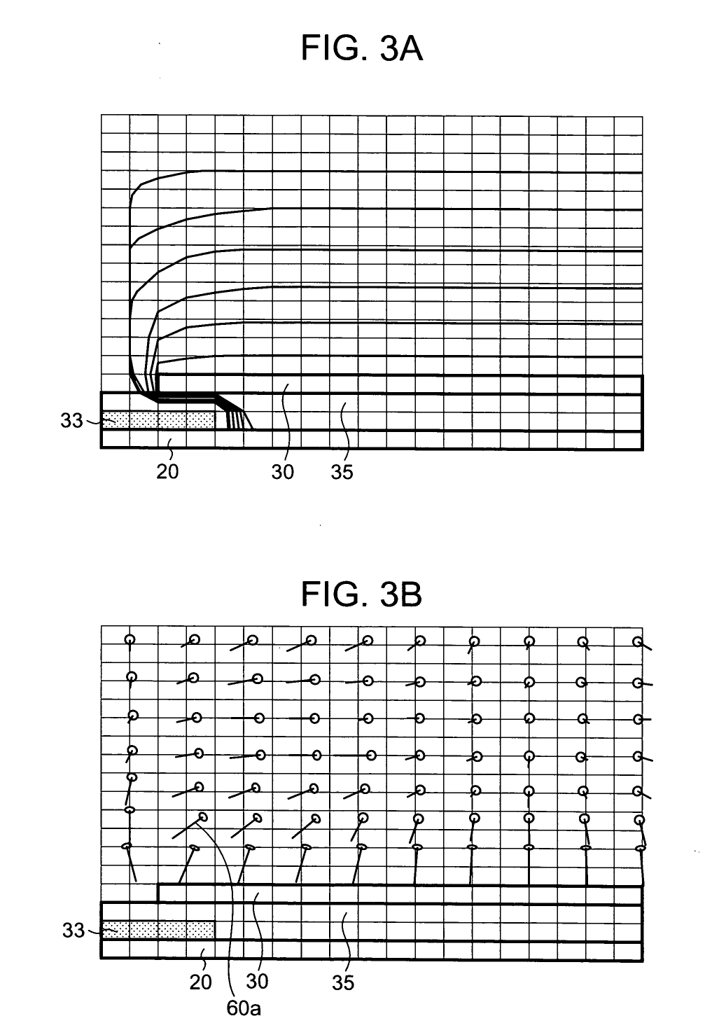

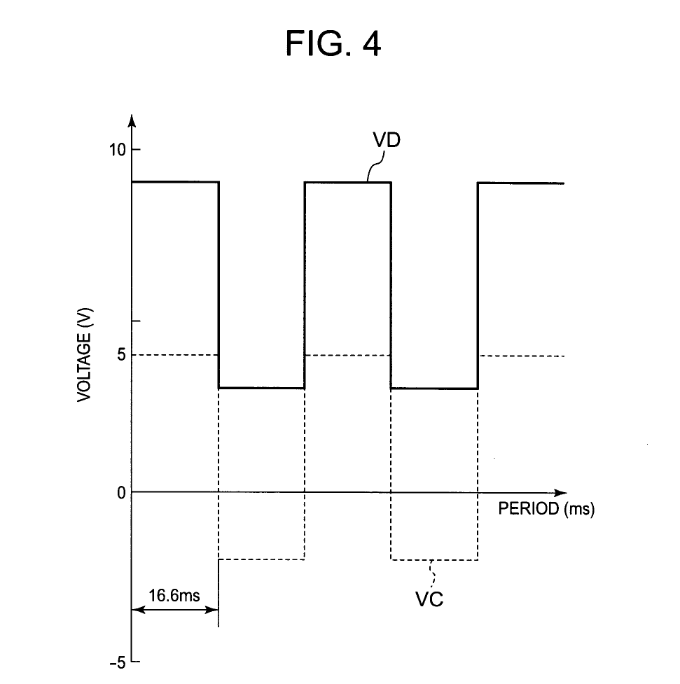

FIGS. 3A and 3B exemplarily illustrate the electric fields at the proximity portions of the slits 30a and the alignment of the liquid crystal molecules in the cross-sectional structure in FIG. 2B. As illustrated in FIG. 4, a drive voltage VD of 3.0 to 9.0 V is applied to the pixel electrode 30 and a drive voltages VC of −2 to 4.0 V are applied to the auxiliary electrode 33 and the opposing electrode 40 at a pulse frequency of 16.6 ms. An electric potential difference of 5.0 V is generated between the pixel electrode 30 and the opposing electrode 40 or the auxiliary electrode 33. This electric potential difference generates horizontal electric fields at the edge portions of the slits 30a in the pixel electrode 30 and between the peripheral edge portion of the pixel electrode 30 and the auxiliary electrode 33. The electric fields become oblique electric fields toward the inside of the pixel electrode 30 from the edge portion of the pixel electrode 30, and become vertical (in the direction perpendicular to the substrates 20 and 10) electric fields at a place sufficiently away from the edges of the pixel electrode 30. The states are represented by the isoelectric lines in FIG. 3A.

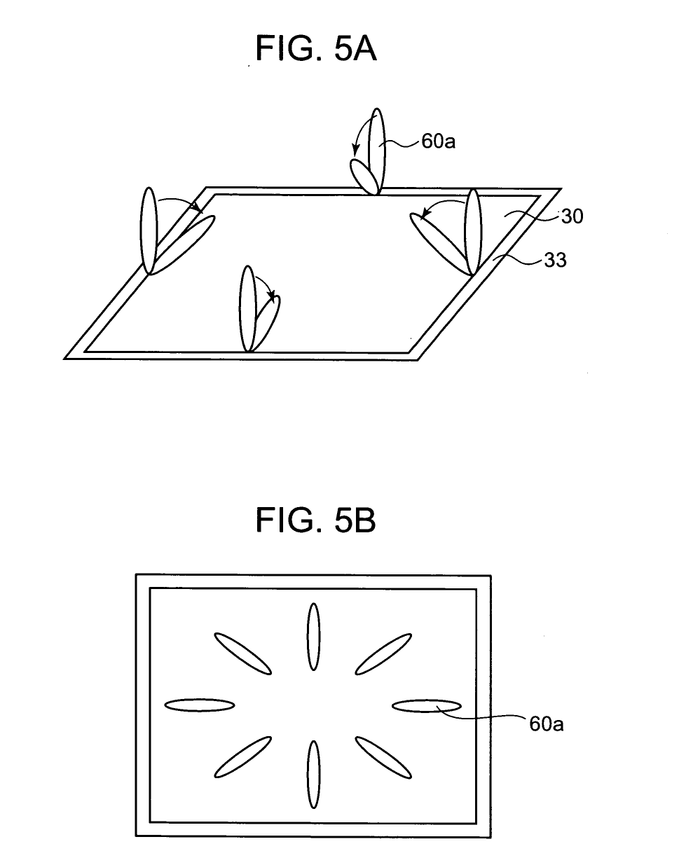

The liquid crystal molecules 60a at the peripheral portions of the sub-pixel regions of the pixel electrode 30 divided by the slits 30a are aligned with the long axis directions (directors) tilted as illustrated in FIG. 3B in such a way as to be perpendicular to the directions of the horizontal electric field at the periphery and the oblique electric field inside the horizontal electric field, that is, along the isoelectric lines in FIG. 3A. As illustrated in FIG. 5A which exemplarily illustrates the behavior of the liquid crystal molecules 60a in each sub-pixel region, the liquid crystal molecules 60a in the vicinity portion of each sub-pixel region behave like leaning toward the inside of each sub-pixel region, and the liquid crystal molecules 60a in the central portion of each sub-pixel region are aligned in such a way that the liquid crystal molecules at the periphery portion lean toward the center, and thus the molecules are aligned perpendicular to the substrate surface due to intermolecular forces. In viewing this state for each sub-pixel region from its cross-sectional direction, as illustrated in FIG. 3B, the liquid crystal molecules 60a are aligned in such a way that their directors are approximately perpendicular to the substrate surface at the outside of the periphery of the pixel electrode 30 and the slits 30a of the pixel electrode 30. The liquid crystal molecules 60a are aligned in such a way that the directors become oblique as the locations of the directors go inward from the periphery of the pixel and the edges of the slits 30a, and the directors become approximately in parallel to the substrate surface at the sufficiently inside. At the central portion of each domain, the liquid crystal molecules 60a are aligned with the directors facing in the direction perpendicular to the substrate.

As illustrated in FIG. 5B which exemplarily illustrates the alignment states of the liquid crystal molecules 60a in each sub-pixel region, in viewing each sub-pixel region from the plane direction, the liquid crystal molecules 60a are aligned with the directors radially aligned toward the periphery for each of the sub-pixel regions of the pixel electrode 30, divided by the slits 30a, from the liquid crystal molecules perpendicularly aligned at the approximate center of each sub-pixel region.

As described above, the slits 30a extending toward the periphery of the pixel from the center of the pixel are formed on the pixel electrode 30 to separate the pixel into a plurality of sub-pixel regions. At the periphery portion of each sub-pixel region for each segmented sub-pixel region, the liquid crystal molecules are aligned toward the center of the sub-pixel region from the periphery thereof, for each sectionalized sub-pixel region, due to the electric field generated in accordance with the voltage applied between the pixel electrode 30 and the auxiliary electrode 33. As a result, a domain where the liquid crystal alignment is discontinuous is formed for each divided sub-pixel region. As the auxiliary electrode 33 is placed on a portion which corresponds to the slits 30a, the alignment of the liquid crystal at the peripheral portion of the domain is stabilized. This results in stable domain formation for the alignment of the liquid crystal molecules formed for each divided sub-pixel region. Accordingly, the display roughness and unevenness can be resolved. As the liquid crystal molecules are aligned toward the center of the domain at each domain, the view angle characteristic is improved.

The auxiliary electrode 33 is formed on the substrate side of the slits 30a for dividing the pixel into sub-pixel regions, and the electric potential of the auxiliary electrode 33 is set lower than that of the pixel electrode 30, preferably set equal to that of the opposing electrode 40. This makes clear a change in electric field at the periphery of the pixel electrode 30 due to the slits 30a, so that the widths of the slits 30a can be narrowed. As a result, an area in one pixel where the behavior of the liquid crystal molecules can be controlled by the electric fields increases, thereby increasing the aperture ratio.

The invention is not limited to the first embodiment, and can be adapted and modified as needed.

Although the auxiliary electrode 33 is formed by a metal film in the embodiment, for example, it is preferable that that portion of the auxiliary electrode 33 which corresponds to the peripheral portion of the pixel electrode 30 should be formed by a metal film of aluminum or the like, and that portion of the auxiliary electrode 33 which corresponds to the slits 30a inside the pixel electrode 30 should be formed by a transparent conductive film.

As the auxiliary electrode 33 comprises the metal film at the peripheral portion of the pixel and the inner transparent conductive film, the light that transmits inside the pixel electrode 30 will not be shielded by the auxiliary electrode 33, thus improving the transmittance of each pixel and providing bright display.

[Second Embodiment]

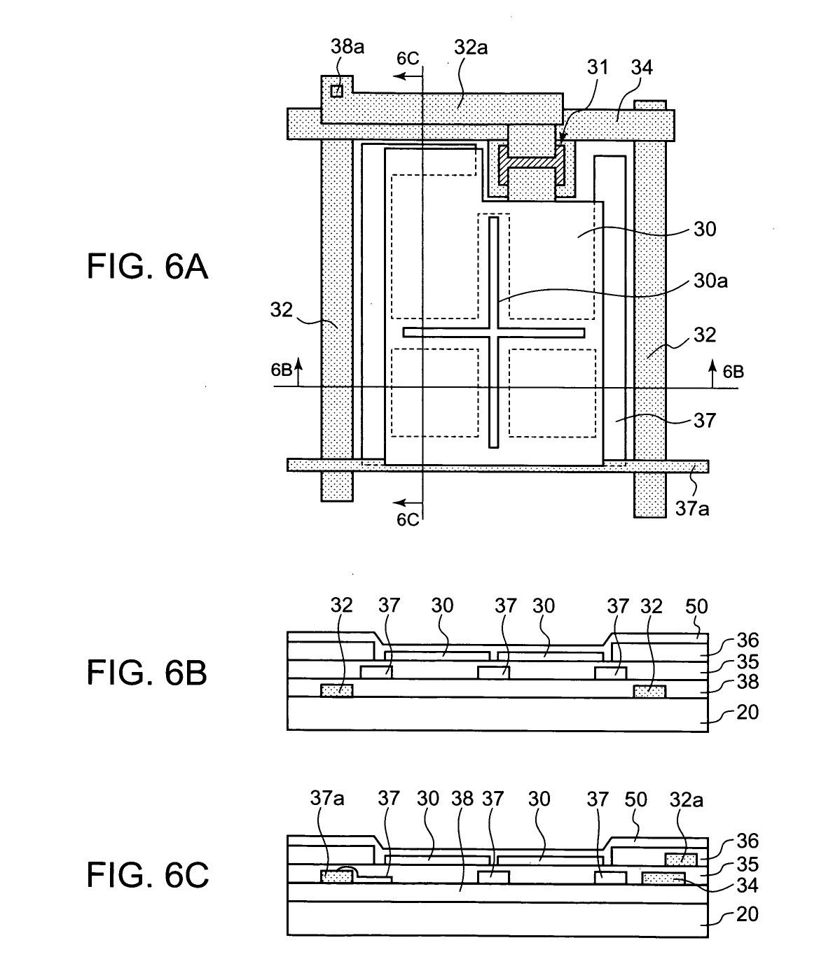

In the first embodiment, although it is explained that the auxiliary electrode 33 is made of aluminum, etc., but the auxiliary electrode 33 may be formed by a transparent electrode comprising a transparent conductive film. In this case, the liquid crystal display device is so structured as to have the cross-sectional structure illustrated in FIGS. 6A to 6C. The same structure portions as those of the above-described embodiment will be denoted by the same reference numbers, and their explanations will be omitted.

In this embodiment, the drain lines 32 are formed on the substrate 20, and an insulation film 38 of silicon nitride is so formed as to cover the drain lines 32. The TFT devices 31, an auxiliary electrode 37, and the gate lines 34 are formed over the insulation film 38 in a similar fashion to that in the first embodiment, and they are covered by the gate insulation film 35. The transparent pixel electrode 30 is formed over the gate insulation film 35.

The auxiliary electrode 37 comprises a transparent electrode formed by an ITO film or the like essentially consisting of an indium oxide, and connected to a metal line 37a made of aluminum or the like arranged close to the pixel electrode 30.

The drain line 32 is connected to a connecting line 32a over the gate insulation film 35 by the insulation film 38 and a through hole 38a provided in the gate insulation film 35, and the connecting line 32a is connected to the drain electrodes of the TFT devices 31.

Next, the method for manufacturing the liquid crystal display device with the structure will be explained.

The drain line 32 is so formed over the substrate 20 as to be apart from the region of the pixel. Subsequently, the insulation film 38 is formed on the substrate 20. Next, the aluminum film is formed on the insulation film 38, and is patterned to form the gate electrodes of the TFT devices 31 and the gate lines 34.

Next, the ITO film is formed on the insulation film 38 by sputtering. The ITO film is etched and patterned to form the auxiliary electrode 37.

Next, the gate insulation film 35 is formed by CVD. Subsequently, the semiconductor layers of the TFT devices 31 are formed on the gate insulation film 35, and the drain and source electrodes are formed.

Subsequently, the ITO film is formed on the gate insulation film 35 by sputtering. The ITO film is etched and patterned, excluding that portion which constitutes the pixel regions of the ITO film, thus yielding the pixel electrodes 30, each formed with the narrow slits 30a extending toward the peripheral portion of the pixel from the center thereof. The metal connecting line 32a is so formed as to be connected to the insulation film 38 via the through hole 38a formed in the gate insulation film 35, and is connected to the drain electrodes of the TFT devices 31. Then, an insulation film 36 is formed on that portion which excludes the region of the pixel. Subsequently, the vertical alignment film 50 is formed on the entire surface of the substrate by CVD, spin coating, etc.

As explained above, in the second embodiment, the pixel electrode 30 is formed with the slits 30a which extend toward the periphery of the pixel from the center thereof as per the first embodiment, the pixel is segmented into a plurality of sub-pixel regions, and the auxiliary electrode 37 is formed on the portion corresponding to the slits 30a Accordingly, the alignment of the liquid crystal in the vicinity of the domain is stabilized, resulting in stable domain formation of the alignment of the liquid crystal molecules which is formed for each divided sub-pixel region. Therefore, the display roughness and unevenness can be resolved. As the liquid crystal molecules are aligned toward the center of the domain at each domain, a view angle characteristic can be improved.

As the auxiliary electrode 37 as the auxiliary electrode which is formed on the substrate side of the slits 30a for dividing the pixel into the plurality of sub-pixel region, has the electric potential lower than that of the pixel electrode 30, and equal to that of the opposing electrode 40, the widths of the slits 30a can be narrowed. As a result, an area which can control the behaviors of the liquid crystal molecules by the electric fields in one pixel is enlarged, thereby increasing the aperture ratio.

As the auxiliary electrode 37 is formed from the transparent conductive film, lights can transmit the region overlapped with the pixel electrode 30. Accordingly, the entire area of the pixel electrode 30 can be the region which can control the transmitting of lights, the light transmittance of the pixel is improved, thereby obtaining the bright displaying.

The invention is not limited to the above embodiments, and can be adapted and modified as needed

For instance, whilst the slits 30a extending from the center of the pixel electrode 30 toward the peripheral portion thereof along the vertical and horizontal directions in each of the above embodiments, but they may be so formed as to extend from the center of the pixel toward the four corners thereof over the diagonal lines of the pixel electrode 30, as long as they are arranged as to sectionalized the pixel electrode 30 in an approximately same shape. The number of the sub-pixel regions sectionalized by the slits is not limited to four, and may be an arbitrary integer which is greater than or equal to two.

Various embodiments and changes may be made thereunto without departing from the broad spirit and scope of the invention. The above-described embodiments are intended to illustrate the present invention, not to limit the scope of the present invention The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2004-210412 filed on Jul. 16, 2004 and No. 2005-204619 filed on Jul. 13, 2005 and including specification, claims, drawings and summary. The disclosure of the above Japanese Patent Applications is incorporated herein by reference in its entirety.

What is claimed is:

1. A liquid crystal display device comprising:
one substrate;
another substrate arranged opposite to the one substrate with a predetermined gap therebetween;
at least one first electrode formed on one surface of opposing surfaces of the one substrate and the other substrate;
a plurality of second electrodes formed on another surface of the opposing surfaces, each formed with a plurality of single pixels each being a region of a minimum display unit by that region which faces the first electrode, and having an aperture for segmenting each pixel into a plurality of sub-pixel regions for each pixel;
a vertical alignment film formed on each of opposing inner surfaces of the one substrate formed with the first electrode and the other substrate formed with the second electrodes;
a liquid crystal layer with a negative dielectric anisotropy filled between the substrates; and
an auxiliary electrode formed on a peripheral region which surrounds at least the second electrode.

2. The liquid crystal display device according to claim 1, wherein the auxiliary electrode is formed in such a manner as to surround each of the plural sub-pixel regions segmented by the aperture.

3. The liquid crystal display device according to claim 1, wherein the auxiliary electrode is so provided as to be associated with the peripheral portion of the second electrode and the aperture.

4. The liquid crystal display device according to claim 1, wherein the aperture comprises, for each of the second electrodes, a plurality of slits which extend from a center of the second electrode to a periphery thereof, and are connected to one another at a center of the pixel electrode.

5. The liquid crystal display device according to claim 1, further comprising an active device, formed on the other substrate and connected to the second electrode, for applying an image signal, supplied externally, to the second electrode, and
wherein the aperture is formed in the second electrode connected to the active device.

6. The liquid crystal display device according to claim 1, wherein the auxiliary electrode is formed on a surface of the other substrate, and
the second electrode is formed on an insulation film which covers the auxiliary electrode on the other substrate.

7. The liquid crystal display device according to claim 1, wherein the first electrode is formed on the one substrate, and
the auxiliary electrode is formed on the other substrate and is applied with a same voltage as is applied to the first substrate.

8. A liquid crystal display device comprising:
one substrate;
another substrate which is arranged opposite to the one substrate with a predetermined gap therebetween;
at least one first electrode formed on that surface of the one substrate which faces the other substrate;
a plurality of second electrodes formed on that surface of the other substrate which faces the one substrate, each formed with a plurality of single pixels defined by a region facing the first electrode, and having a slit for segmenting each pixel into a plurality of sub-pixel regions for each pixel;
a vertical alignment film formed on each of that surface of the one substrate on which the first electrode is formed and that surface of the other substrate on which the second electrodes are formed;
a liquid crystal layer with a negative dielectric anisotropy filled between the substrates;
a first auxiliary electrode, formed on that surface of the other substrate on which the second electrodes are provided at a peripheral region surrounding at least the second electrodes, for aligning liquid crystal molecules located at a periphery of a pixel of the liquid crystal layer in such a way that a molecular long axis of the liquid crystal molecules tilt from a periphery to a center by an electric field applied between the first auxiliary electrode and the second electrode; and
a second auxiliary electrode, formed on that surface of the other substrate on which the second electrodes are formed at a region corresponding to the slit, for aligning liquid crystal molecules located at a periphery of a sub-pixel region of the liquid crystal layer, for each sub-pixel region, in such a way that the molecular long axis of the liquid crystal molecules tilt from a periphery to a center by an electric field applied between the second auxiliary electrode and the second electrode.

9. The liquid crystal display device according to claim 8, wherein the slit comprises a plurality of notch sections formed in such a way as to extend from a center of the pixel region to a periphery thereof and be connected to one another at a center portion of the pixel region.

10. The liquid crystal display device according to claim 8, further comprising an active device, formed on the other substrate and connected to the second electrode, for applying an image signal, supplied externally, to the second electrode, and
wherein the slit is formed in the second electrode connected to the active device.

11. The liquid crystal display device according to claim 8, wherein:
the first and second auxiliary electrodes are formed on a surface of the other substrate; and
the second electrode is formed on an insulation film which covers the first and second auxiliary electrodes on the other substrate.

12. The liquid crystal display device according to claim 8, wherein the first auxiliary electrode and the second auxiliary electrode are formed on a surface of the other substrate so as to be connected to each other.

13. The liquid crystal display device according to claim 8, wherein the first and second auxiliary electrodes are set to lower electric potentials than an electric potential of the second electrode.

14. The liquid crystal display device according to claim 8, wherein the first and second auxiliary electrodes are set to an electric potential equal to an electric potential of the first electrode opposite to the second electrode.

15. The liquid crystal display device according to claim 8, wherein the first auxiliary electrode comprises a compensating-capacitor electrode which overlaps the peripheral portion of the second electrode, and forms a compensating capacitor between the second electrode and the compensating-capacitor electrode.

16. The liquid crystal display device according to claim 8, wherein the second auxiliary electrode is formed wider than a width of the slit of the second electrode, and that region of the second auxiliary electrode which overlaps the second electrode forms a compensating capacitor between the second electrode and the second auxiliary electrode.

17. The liquid crystal display device according to claim 8, wherein each of the first and second auxiliary electrodes comprises a transparent conductive film.

18. A liquid crystal display device comprising:
one substrate;
another substrate arranged opposite to the one substrate with a predetermined gap therebetween;
at least one first electrode formed on one surface of opposing surfaces of the one substrate and the other substrate;
a plurality of second electrodes formed on another surface of the opposing surfaces, and each formed with a plurality of single pixels each being a region of a minimum display unit by that region which faces the first electrode;
a vertical alignment film formed on each of opposing inner surfaces of the one substrate formed with the first electrode and the other substrate formed with the second electrodes;
a liquid crystal layer with a negative dielectric anisotropy filled between the substrates; and
segmentation means, provided on the second electrode, for segmenting each pixel into a plurality of sub-pixel regions; and
alignment means, provided on the second substrate, for aligning liquid crystal molecules located around the sub-pixel region of the liquid crystal layer in such a way that a molecular long axis tilt from a periphery to a center for each sub-pixel region.

19. The liquid crystal display device according to claim 18, wherein the segmentation means comprises a plurality of slits formed on the second electrode.

20. The liquid crystal display device according to claim 18, wherein the alignment means comprises auxiliary electrodes formed on that surface of the other substrate on which the second electrodes are formed at a peripheral region surrounding at least the second electrodes, and a region corresponding to the segmentation means.
